(19) United States
(12) Patent Application Publication
(10) Pub. No.: US 2015/0358507 A1
(43) Pub. Date: Dec. 10, 2015

(54) TIMING RECOVERY FOR EMBEDDED METADATA

(71) Applicant: Sony Corporation, Tokyo (JP)

(72) Inventor: Mark EYER, Woodinville, WA (US)

(73) Assignee: Sony Corporation, Tokyo (JP)

(21) Appl. No.: 14/295,695

(22) Filed: Jun. 4, 2014

(51) Int. Cl. H04N 5/04

(52) U.S. Cl. CPC H04N 5/04

(57) ABSTRACT

A method, non-transitory computer-readable storage medium, and reception apparatus for processing metadata, and an information providing apparatus for providing the metadata. The method for processing metadata includes processing content that includes a plurality of metadata embedded therein for presentation to a user. Each of the metadata includes the same payload data and different timing recovery data. As the content is processed, one of the plurality of metadata is extracted from an audio or video portion of the content. A determination is made as to whether a first instance of the payload data is included in the extracted one of the plurality of metadata based on the timing recovery data included in the extracted one of the plurality of metadata.

### BACKGROUND OF THE INVENTION

1. Field of the Invention

Embodiments described herein relate generally to a method, non-transitory computer-readable storage medium, and reception apparatus for processing metadata; and a method, non-transitory computer-readable storage medium, and an information providing apparatus for providing the metadata.

2. Background

Modern television receivers are capable of performing numerous processes in addition to receiving and presenting television content. To perform these additional processes, a television receiver may need to access additional data and perform a process that is synchronized to one or more particular segments of the television content. In order to ensure synchronization, the television receiver device should be able to determine timing information of the content.

### SUMMARY OF THE INVENTION

Embodiments of the present disclosure relate to effective timing recovery for metadata. Although the present disclosure is primarily described using metadata embedded in a portion of uncompressed audio and/or video data, the embodiments can be applied to metadata embedded in other data (e.g., video or audio “user data”, closed caption data) or otherwise provided with the audio and/or video data (e.g., as a separate data portion in a transport multiplex).

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates an exemplary broadcast system;

FIG. 2 is a block diagram of an exemplary reception apparatus;

FIG. 3 is a processor-centric block diagram of an exemplary reception apparatus;

FIG. 4 illustrates a flow diagram of an exemplary method for processing metadata;

FIG. 5 illustrates an exemplary syntax for metadata;

FIG. 6 illustrates an exemplary syntax for a payload data portion of the metadata;

FIG. 7 illustrates an exemplary information providing apparatus;

FIG. 8 illustrates a flow diagram of an exemplary method for providing metadata; and

FIG. 9 is an exemplary computer.

### DETAILED DESCRIPTION

While the present disclosure is susceptible of embodiment in many different forms, there is shown in the drawings and will herein be described in detail specific embodiments, with the understanding that the present disclosure of such embodiments is to be considered as an example of the principles and not intended to limit the present disclosure to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a program module, a script, a function, a procedure, an object method, an object implementation, in an executable application, an applet, a servlet, a source code, an object code, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio/video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an EPG.

Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Embodiments of the present disclosure relate to effective timing recovery for embedded metadata. Although the present disclosure is primarily described using metadata embedded in a portion of uncompressed audio and/or video data (e.g., modulated within the video itself in luminance or chrominance), a variety of transport methods are possible for the metadata. The metadata can be included in the digital transport multiplex in a variety of different locations, or it can be provided by an Internet-based server and accessed by receivers that are Internet-connected. Possible locations in the digital transport include in video or audio “user data,” within the closed captioning transport (e.g., using one of the standard copy services such as service number 6), within a descriptor carried in a program specific information (PSI) table, and within adaptation fields of the MPEG-2 Transport Stream packet.

In one example, the metadata is embedded as a watermark in video data. Although the watermark delivered in video can be recovered and error-checked, if a receiver detects an error, the payload data must be discarded. Therefore, if the particular payload data that was discarded identified a particular frame for the purposes of frame-level synchronization, the receiver's use of subsequent repetitions of the same data would cause a synchronization error to occur corresponding to the number of frames of data that were dropped due to errors.

Embodiments of the present disclosure may be utilized to enhance the signaling methodology used in the application of metadata (e.g., video embedded metadata) for the purposes of improving the ability to indicate frame-accurate timing, or other timings (e.g., media timing), in cases where one or more error-free instances of the metadata cannot he recovered. An example of video embedded metadata is described in U.S. Patent Application Publication No. 2011/0088075, System and Method for Distributing Auxiliary Data Embedded in Video Data, which is incorporated herein by reference in its entirety.

For example, certain embodiments of the present disclosure allow a content providers such as a broadcaster or other service provider to include data embedded in the audio and/or video portion of content such that it could be recovered in instances where a receiver only has access to the uncompressed audio/video (and no access to the compressed data, or accompanying metadata). This may arise, for example, when the receiver is connected via HDMI to a digital cable or satellite set-top box.

Metadata in the uncompressed audio/video could allow the receiver to identify the source of the content, and using an Internet connection, access appropriate auxiliary content provided by the broadcaster or content/service provider's server to enhance a viewer's enjoyment of the content. The auxiliary content may be associated with, and synchronized in time to events within content provided by a content provider. The auxiliary content may include one or a combination of media types such as audio, video, text, or an image, and/or one or more interactive elements (e.g., an interactive television application). Further, the behavior and appearance of the auxiliary content may be associated with, and synchronized in time to the events within, the content.

In interactive television applications, viewers are offered extra content, in addition to the program audio and video, that allows them to interact with the programming in some way. The extra content could be as simple as an Internet universal resource locator (URL) that points to a website that can provide further information about the program, item, or service being shown. Or, the interactive element could provide text and graphics that augment the program video. An example of the latter is an element that displays a particular player's updated statistics during the course of a sporting event.

Often, the behavior or appearance/disappearance of these interactive elements is dependent on the timing of events within the program. Television receivers which are rendering these objects must be able to receive the appropriate signaling to know how and when to make the adjustments to the display of the interactive elements. The objects which perform this signaling function may be called “triggers” because they act to trigger a certain operation at the designated time. The varieties of operations that may be triggered are endless. Simple examples include such things as “execute” (start the operation of the interactive function), “hide” (remove all visible elements from the display), perform some designated action such as display some text or graphic, and “terminate” (end all operations and release memory resources).

As described in further detail below, certain embodiments of the present disclosure add timing recovery data to embedded data (e.g., via a video watermark) that allows a receiver to recognize that a current repeated instance of the embedded data is not the first in the group. By noting the value of the timing recovery data (e.g., a repeat sequence field) in the embedded data, the frame accuracy of the video watermark instance is maintained even if the first one of the group of repeated instances is not recoverable in the receiver.

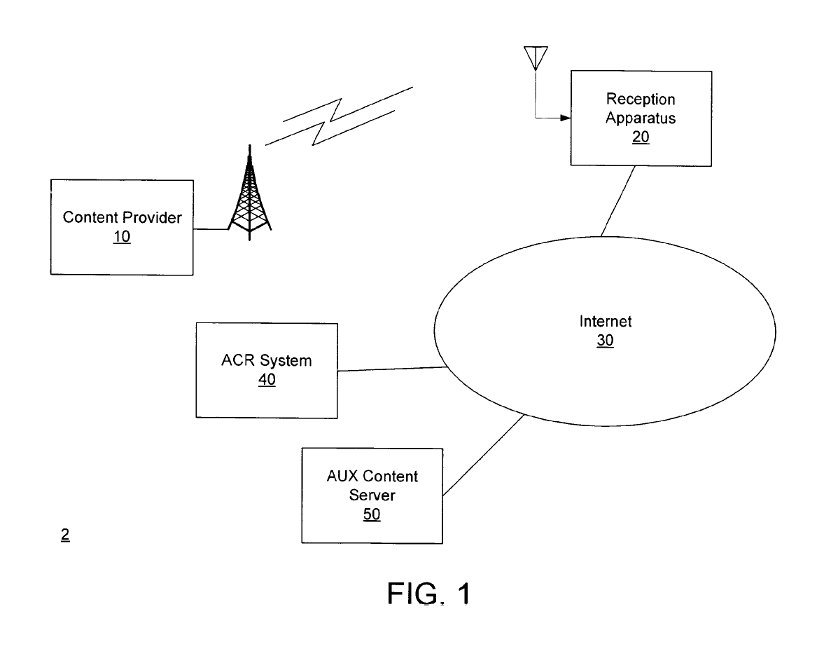

Referring now to the drawings, FIG. 1 is a block diagram that shows an exemplary broadcast system 2, including a content provider 10, a reception apparatus 20, an optional automatic content recognition (ACR) system 40, and an auxiliary content server 50. The reception apparatus 20 accesses the ACR system 40 and/or auxiliary content server 50 via one or more communication networks such as the Internet 30.

The content provider 10, which may be a broadcaster or other service provider, provides content and associated metadata to the reception apparatus 20. Multiples instances of the metadata with the same payload data are repeatedly provided with the content at different times (e.g., embedded in different video frames). Multiple instances of metadata with the same payload data are repeated in the emission to, for example, improve robustness against one or more symbol errors that can occur in the case that transcoding or low-bit rate encoding has corrupted one or more instances of the metadata. Thus, even if a first instance of the metadata cannot be recovered by the reception apparatus 20, the same payload data may be acquired at a later point within the broadcast of the content.

In certain embodiments, the metadata is embedded in the content itself. For example, the metadata is embedded in an audio and/or video portion of the content and recovered by processing the decoded audio and/or video of the content in the reception apparatus 20. In the case of frame-accurate timing, payload data associated with a given frame of content is placed within that same frame. The reception apparatus 20 extracts the payload data and associates it directly with the presentation timing of that frame.

The content provider 10 provides content to the reception apparatus 20 via a terrestrial broadcast according to one embodiment. In other embodiments, the content provider 10 provides the content via at least one of a satellite broadcast, a cable television transmission, a terrestrial television broadcast, cellular network, and data communication network such as a local area network (LAN), wide area network (WAN), or the Internet 30. The content provided by the content provider 10 includes one or more television programs, without regard to whether the content is a movie, sporting event, segment of a multi-part series, news broadcast, etc. Further, the content provided by the content provider 10 may also include advertisements, infomercials, and other program-like content which may not be reported as a program in an EPG. The content provider 10 may also provide content that contains only audio or only video.

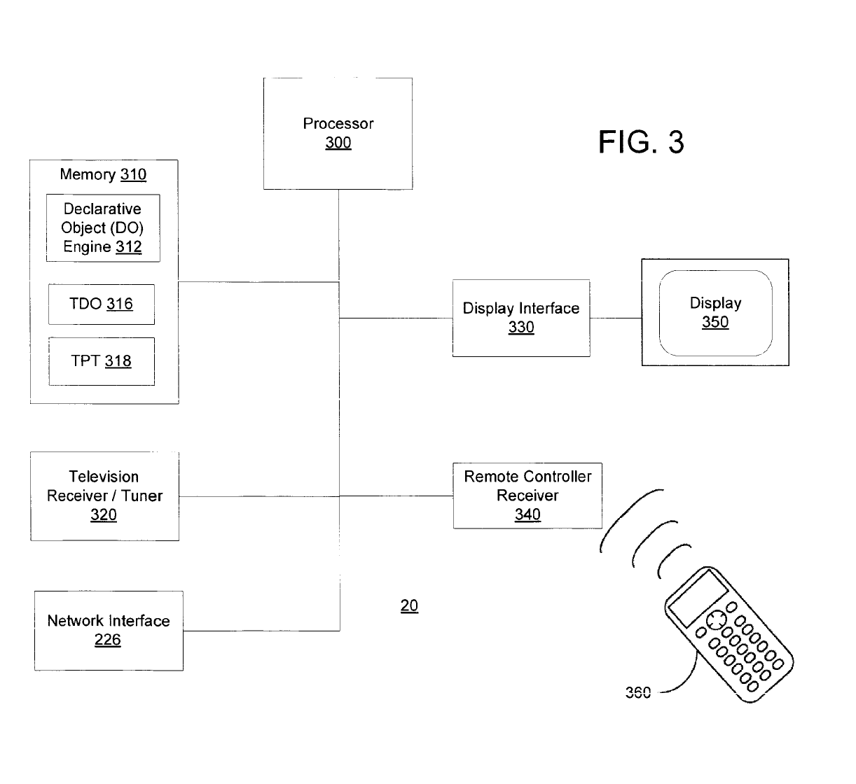

The reception apparatus 20 receives the content provided by the content provider 10 and displays the content on a display, for example the display 350 illustrated in FIG. 3. The display 350 may he an integral part of the reception apparatus 20 such as a television set. Alternatively, the display 350 may be external to the reception apparatus 20 such as a television set connected to a set top box.

The optional ACR system 40, in certain embodiments, provides additional data associated with the content provided by the content provider 10. For example, the reception apparatus 20 acquires the additional data by sending content identifying information, or a code contained in the metadata, to the ACR system 40. Examples of additional data include the auxiliary content itself or information necessary to acquire the auxiliary material (e.g., a location of the auxiliary material when the location is not contained in the metadata).

The auxiliary content server 50 stores auxiliary material. Examples of auxiliary material include a Triggered Declarative Object (TDO), a TDO Parameters Table (TPT), a trigger, etc. In certain embodiments, the reception apparatus 20 retrieves the auxiliary material from the auxiliary content server 50 based on information received from the ACR system 40. Although the auxiliary content server 50 is illustrated as a separate component of the system in FIG. 1, it should be noted that the auxiliary content server 50 may he incorporated in the content provider 10 or the ACR system 40 in certain embodiments.

According to one embodiment, the reception apparatus 20 includes a Declarative Object (DO) Engine, for example the DO Engine 312 illustrated in FIG. 3, that accepts declarative objects (DOs) and renders them along with the content (e.g., audio/video content of a program) received from the content provider 10. The DO Engine renders a DO in response to a specific request from a user or in response to a trigger event. A DO that is rendered in response to a trigger event is referred to as a Triggered Declarative Object, or TDO.

A TDO is a downloadable software object created by a content provider, content creator, or other service provider types, which includes declarative content (e.g., text, graphics, descriptive markup, scripts, and/or audio) whose function is tied in some way to the content it accompanies. An embodiment of the TDO is described in the ATSC Candidate Standard: Interactive Services Standard (A/105:2014, S13-2-389r7), which is incorporated herein by reference in its entirety. However, the TDO is not limited to the structure described in the ATSC Candidate Standard since many attributes defined therein as being a part of a TDO could be situated in a trigger or vice versa or not present at all depending upon the function and triggering of a particular TDO.

The TDO is generally considered as “declarative” content to distinguish it from “executable” content such as a Java applet or an application that runs on an operating system platform. Although the TDO is usually considered to be a declarative object, a TDO player (e.g., the DO Engine) supports a scripting language that is an object-oriented programming language. The TDOs, in examples shown herein, are received from a content or service provider, via for example the auxiliary content server 50, in advance of the time they are executed so that the TDO is available when needed. Moreover, an explicit trigger signal may not be necessary and a TDO may be self-triggering or triggered by some action other than receipt of a trigger signal. Various standards bodies may define associated behaviors, appearances, trigger actions, and transport methods for content and metadata for a TDO. Additionally, requirements regarding timing accuracy of TDO behaviors relative to audio/video may be defined by standards bodies.

The trigger is a data object, which is optionally bound to a particular item or segment of content (e.g., a television program) that references a specific TDO instance, by the use of a file name or identifier for an object that has already been or is to be downloaded. Certain TDOs will only make sense in conjunction with certain content. An example is a TDO that collects viewer response data, such as voting on a game show or contest. An exemplary trigger format is described in further detail below.

The TPT contains metadata about a TDO of a content segment and defines one or more events for the TDO. The events of the TDO may be triggered based on a current timing of the content being reproduced or by a reference to one or more events contained in one or more triggers. For example, one or more parameters associated with a trigger may be provided to the reception apparatus 20 in the TPT.

While a trigger indicates that the time is right for the TDO to perform a certain action, a series of timed actions can be played out without a trigger, for example by using the TPT. The TPT optionally provides timing information for various interactive events relative to “media time.” Each item of interactive content has a timeline for its play out; an instant of time on this timeline is called media time. For example, a 30-minute program may have an interactive event at media time ten minutes, 41 seconds, and 2 frames from the beginning of the program, or media time 10:41+02. The TPT can include an entry indicating the details of the event that is to occur at time 10:41+02. Once the reception apparatus 20 determines the current timing relative to the start of the program, it can use the TPT to play out all subsequent events.

Alternatively, the timing of execution of specific interactive events is determined by the appearance of a trigger referencing a specific event. When the reception apparatus 20 receives a trigger, the event referenced in the TPT is executed.

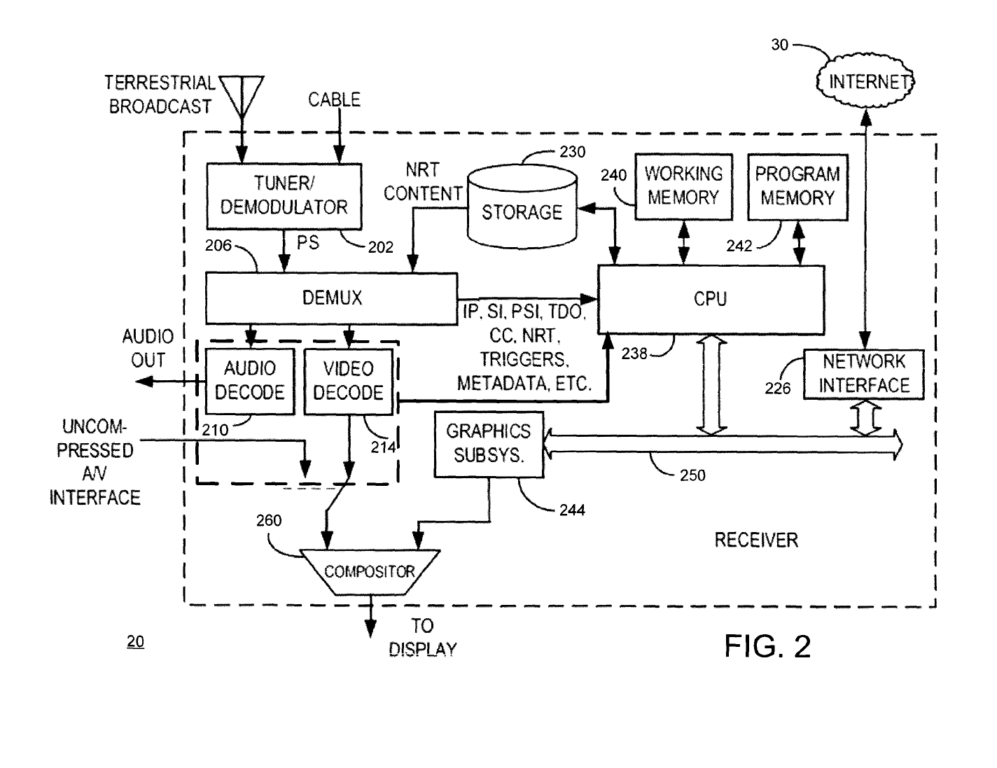

FIG. 2 illustrates an embodiment of the reception apparatus 20. The reception apparatus 20 is a digital television receiver device that may be incorporated into a television set or a set top box. The reception apparatus 20 includes a tuner/demodulator 202, which receives content from one or more content providers such as a terrestrial broadcast or a cable television transmission. The reception apparatus 20 may also, or alternatively, receive content from a satellite broadcast. The tuner/demodulator 202 receives a packet stream (PS) such as a transport stream (TS) or IP packet stream, which is demultiplexed by the demultiplexer 206 into audio and video (A/V) streams. Exemplary IP packet streams are described in the ATSC Mobile DTV standard ATSC-M/H (A/153) and the Enhanced Multicast Multimedia Broadcast (eMBMS) standard, which are incorporated herein by reference in their entirety. The audio is decoded by an audio decoder 210 and the video is decoded by a video decoder 214. Further, uncompressed A/V data may be received via an uncompressed A/V interface (e.g., a HDMI interface) that can be selectively utilized. The uncompressed A/V data may be received from a set-top box, digital video recorder, DVD player, or any other consumer electronics device connected to the reception apparatus 20 via the uncompressed A/V interface.

The TS may include ancillary information such as one or more of caption data, TDOs, triggers, TPTs, content identifiers, and other metadata. One or more of the A/V content and/or the ancillary information may also be received via the Internet 30 and a network interface 226. In certain embodiments, ancillary information such as one or a combination of the triggers, content identifiers, caption data, or other metadata is embedded, or otherwise inserted, in an audio and/or video portion of the A/V content. A CPU 238 extracts the ancillary information from the audio and/or video portions of the A/V content and performs one or more processes based on the extracted ancillary information.

A storage unit 230 is provided to store NRT or Internet-delivered content such as Internet Protocol Television (IPTV). The stored content can be played by demultiplexing the content stored in the storage unit 230 by the demultiplexer 206 in a manner similar to that of other sources of content. The storage unit 230 may also store one or more TDOs, triggers, and TPTs acquired by the reception apparatus 20.

The reception apparatus 20 generally operates under control of at least one processor, such as the CPU 238, which is coupled to a working memory 240, program memory 242, and a graphics subsystem 244 via one or more buses (e.g., bus 250). The CPU 238 receives closed caption data from the demultiplexer 206 as well as any other information such as TDO announcements and EPGs used for rendering graphics, and passes the information to the graphics subsystem 244. Graphics outputted by the graphics subsystem 244 are combined with video images by the compositor and video interface 260 to produce an output suitable for display on a video display.

Further, the CPU 238 operates to carry out functions of the reception apparatus 20 including the processing of related triggers, TDOs, TPTs, browser operations, metadata, etc. The browser operations include accessing a service specified by a URL given by the TDO or trigger. The CPU 238 further operates to execute script objects (control objects) contained in the TDO, its trigger(s), etc., using for example DO Engine 312 illustrated in FIG. 3.

Although not illustrated in FIG. 2, the CPU 238 may be coupled to any one or a combination of the reception apparatus 20 resources to centralize control of one or more functions. In one embodiment, the CPU 238 also operates to oversee control of the reception apparatus 20 including the tuner/demodulator 202 and other television resources.

A more processor-centric view of the reception apparatus 20 is illustrated in FIG. 3. Memory and storage 230, 240, and 242 are depicted collectively as memory 310. Further, a processor 300 includes one or more processing units such as CPU 238. Similarly, the various demodulators, decoders, etc., that initially process digital television signals are collectively depicted as television receiver/tuner 320. The reception apparatus 20 further includes a remote controller 360 which communicates with a remote controller receiver interface 340. Additionally, the display 350 is connected to a display interface 330, which includes for example the uncompressed A/V interface and/or compositor 260, and is either a display integral to the reception apparatus 20 as in a television set or a connected display device as in the case where the reception apparatus 20 is integrated into a set-top box.

Memory 310 contains various functional program modules and data. The memory 310 stores the data used by the reception apparatus 20. The memory 310 within the reception apparatus 20 can be implemented using disc storage form as well as other forms of storage such as non-transitory storage devices including for example network memory devices, magnetic storage elements, magneto-optical storage elements, flash memory, core memory and/or other non-volatile storage technologies. The term “non-transitory” is a limitation of the medium itself (i.e., tangible, not a signal) as opposed to a limitation on data storage persistency (e.g., RAM vs. ROM).

When a TDO 316 is received, the TDO 316 is stored in the memory 310. The TDO execution is carried out by a DO Engine 312. The TDO, when executed by the DO Engine 312 presents auxiliary content based on one or more triggers associated with the TDO. The memory 310 also stores a TPT 318, which in one embodiment, defines one or more parameters for each trigger associated with the TDO.

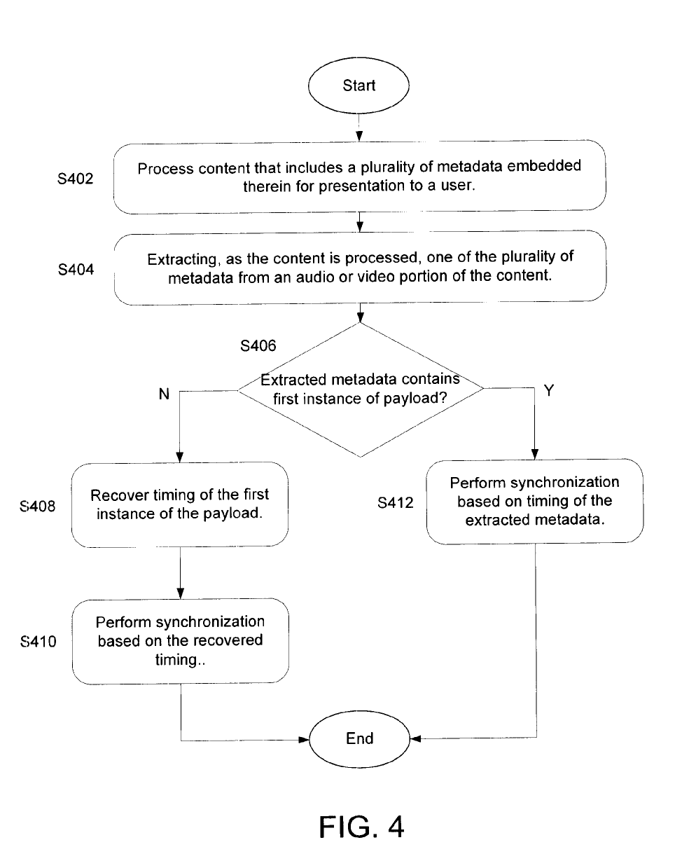

FIG. 4 provides an overview of an exemplary method for processing metadata embedded in content (e.g., audio and/or video content). The content includes a plurality of metadata that is repeatedly embedded therein. Each of the plurality of metadata typically includes the same payload data but different timing recovery data. An exception may arise in certain embodiments, for example when multiple copies of the metadata are embedded in multiple lines (e.g., lines 1 and 2) of a single frame of the content. In this example, multiple copies of metadata on the multiple lines of the single frame may include the same timing recovery data. Alternatively, the timing recovery data may be defined in a manner that distinguishes between repeated instances within the same frame versus different frames. For example, the timing recovery data could have a value of 0 for a first instance and 0.5 for a second instance within the same frame. The reception apparatus 20 performs synchronization based on the timing recovery data extracted from one of the plurality of metadata.

The process begins at step 402, at which time the content is processed (e.g., decoded, reproduced) for presentation to a user by the reception apparatus 20. In one embodiment, the content is provided to the reception apparatus 20 and the content is decoded and presented in real-time. For example, the content is provided to the reception apparatus 20 via a digital television broadcast, through a cable television transmission, or satellite broadcast. However, in other embodiments, the reproduced content is streamed over the Internet or previously downloaded or recorded by the reception apparatus 20.

In step S404, as the content is being processed, the reception apparatus 20 performs further processing of a processed segment of the content (e.g., a decoded frame) to determine whether metadata is embedded therein. In one embodiment, when metadata is embedded in a video portion of the content, the reception apparatus 20 determines whether a given frame of the content includes embedded metadata. For example, the reception apparatus 20 determines whether or not metadata which is embedded as a watermark is present by sampling the luminance values in the first few pixels of line 1, or another line, of the given frame.

Any processor (e.g., CPU 238) within the reception apparatus 20 that has access to the video buffer may extract luminance data from line 1, and optionally line 2, and recover the watermark. For example, the processor looks for a data indicator pattern in the first set of luminance samples. If one is not found, the processor waits until the next frame. Otherwise, the processor processes video samples to recover the portion of the watermark data up to and including, for example, a payload sequence. If any of this data is different than that seen recently on the same service, the processor recovers a payload length (n) and n bytes following. Next, the processor may compute a checksum and discard the watermark data if it does not check.

In step S406, when the embedded metadata is detected, the reception apparatus 20 processes the metadata and determines whether the payload data included in the metadata is the first instance of the payload data, or the first instance of a repeated sequence of the payload data, embedded in the content. The reception apparatus 20 makes this determination based on timing recovery data included in the metadata.

Depending on the embodiment, subsequent instances of the same payload data may be ignored or utilized to fine-tune synchronization. Further, the determination of whether the payload data is included in the extracted metadata may not be necessary for certain payload types. In such cases, the reception apparatus 20 may first determine whether to perform the determination in step S406 by first examining the payload type for the extracted metadata.

In one embodiment, the metadata includes repeat sequence information that indicates which instance of the same payload data, or of a repeated sequence of the payload data, is included in the processed metadata. For example, a first instance of payload data is identified by the repeat sequence information with a predetermined number (e.g., 0), which is incremented by a predetermined amount for each subsequent instance of the same payload data.

When the reception apparatus 20 determines that the extracted metadata does not contain the first instance of a set of repeated payload data, in step S408, the reception apparatus 20 recovers the timing of the first instance of the same payload data based on the timing recovery data. In one embodiment, the repeated payload data are contained in metadata that is embedded in consecutive frames of the content. Accordingly, the reception apparatus 20 determines the number of video frames that have passed, since the video frame associated with the first instance of the same payload data, based on the timing recovery data (e.g., repeat sequence information).

For example, the timing recovery data (e.g., repeat sequence information) may indicate how many frame times ago the first instance was sent. In this example, based on repeat sequence information with a value of ‘2’, the reception apparatus 20 determines two video frames have passed, since the video frame associated with the first instance of the same payload data. In another embodiment, the number of frames is determined based on a predetermined number of frames (i.e., the number of frames between frames containing embedded metadata) multiplied by the number 2.

In certain embodiments, a predetermined number of frames is not required in order for the reception apparatus 20 to perform timing recovery. In such embodiments, the predetermined number of frames, or any other information required by the reception apparatus 20 to determine the timing, can be provided to the reception apparatus 20 via the extracted metadata or using other communication methods.

In step S410, the reception apparatus 20 performs synchronization based on the recovered timing of the first instance of the same payload data. Alternatively, when the reception apparatus 20 determines that the extracted metadata does contain the first instance of the payload data, in step S412, the reception apparatus 20 performs synchronization based on the timing of the extracted metadata. For example, the reception apparatus 20 performs synchronization based on the frame in which the extracted metadata was embedded. In another example, the reception apparatus 20 performs the synchronization based on the timing of the first instance of the metadata and timing information included in the extracted metadata (e.g., in a payload data portion). Media time and other reference points may be used instead of using frames as a reference.

For example, in one embodiment, the reception apparatus 20 performs synchronization by determining a current media time of the content being reproduced based on a trigger included in the extracted metadata. The reception apparatus 20 determines the media time internally and uses the media time defined in the trigger and the timing of the first instance of the metadata for synchronization purposes or as a reference point to determine the elapsed time at any point of the received content. It should be noted that the media time is not limited to representation in terms of minutes and seconds and can use any other increments of time or reference points such as video frames or other methods providing sub-second accuracy to designate the timing of the events.

After performing synchronization in either steps S410 or S412, the reception apparatus 20 performs a process that is synchronized with the content being reproduced.

One example involves an interactive services trigger per the ATSC A/105 standard, in which the trigger identifies the location of an interactive script (the TDO) as well as media timing. In other words, an instance of the trigger includes data that indicates to the reception apparatus 20 the timing location in the content to sub-frame-level accuracy. In this example, the trigger is

xbc.tv/e12?m=100a

indicating that the table providing the location of the TDO can be found at http://xbc.tv/e12 and that the media time is 4106 milliseconds after the start of the program (4106 decimal is hexadecimal 100a). If this trigger is received by the reception apparatus 20 and within the watermark found to have a sequence value of 3, the reception apparatus 20 understands that the first three instances had been discarded due to checksum failure, and thus the media time of 4106 milliseconds corresponded to a media time three frames (at 30 frames per second, 100 msec) earlier. Thus, the reception apparatus 20 can associate the current timing with media time 4206 milliseconds.

As described above, the reception apparatus 20 includes circuitry, for example as illustrated in FIGS. 2 and 3, to perform the metadata processing method of FIG. 4.

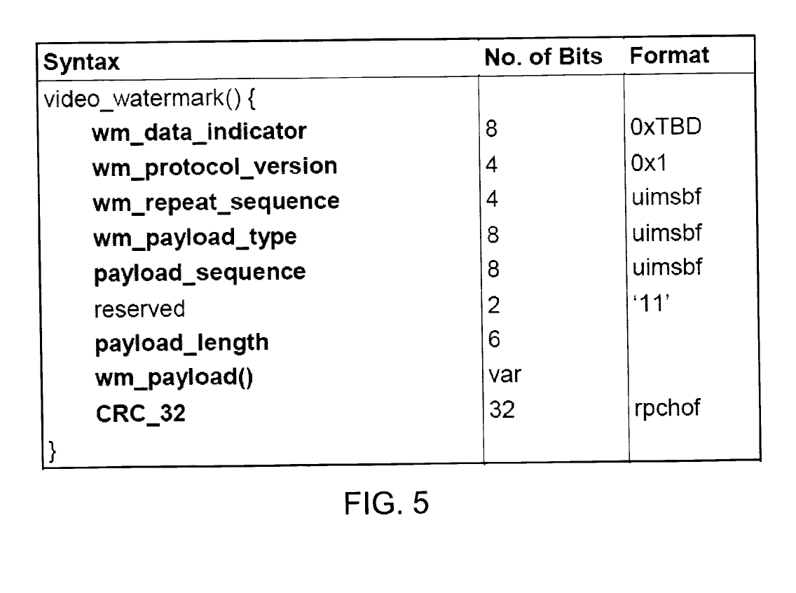

FIG. 5 provides an example of a bit stream syntax for a video watermark. The video watermark is an example of embedded metadata processed by the method discussed with respect to FIG. 4. The reception apparatus 20 is designed to respond to new instances of data payloads. A data field, payload sequence, is used to identify new payload contents. If the reception apparatus 20 encounters another payload with the same values of other fields (e.g., wm_data_indicator, wm_protocol_version, wm_payload_type, payload_sequence), it recognizes this instance as a repeat and, in one embodiment, performs no further processing. In another embodiment, the reception apparatus 20 uses the repeat instances to fine-tune synchronization. As noted above, if the reception apparatus 20 has discarded any of the first instances in a repeated group, the timing of the first instance is lost and needs to be recovered.

The encoded data begins with a watermark “data indicator,” which is an 8-bit signed unsigned integer that includes a pattern of symbols identifying the data to follow as a watermark. An additional function of the data indicator is to ensure that regular video will not be processed as a watermark.

The encoded data further includes a watermark “protocol version,” which is a 4-bit unsigned integer that identifies the version of the protocol used to deliver the data structure to follow. In one embodiment, the initial value of the protocol version is set to ‘0001’. Receivers (e.g., the reception apparatus 20) are expected to disregard instances of the watermark in which the value of the protocol version is not recognized.

The watermark “repeat sequence” identifies the instance of a repeated video watermark. The repeat sequence is a 4-bit unsigned integer in the range 0 to 15 and identifies an instance of a repeated video_{—} watermark( )(e.g., one with identical values for wm_data_indicator, wm_protocol_version, wm_payload_type, payload_sequence, payload_length, and wm_payload( )). Value 0 indicates the first instance, value 1 indicates the second instance, etc. In the case of 16 or more instances of the same payload data, the value of the repeat sequence is set to 15 (‘1111’). For values less than 15, the receiver can process the repeat sequence to recover the timing of the first instance in the group of repeated watermarks in case one or more of the first instances is unrecoverable.

The watermark “payload type” is an 8-bit unsigned integer that identifies the type of payload delivered in the wm_payload( )data structure to follow. Exemplary payload types include payload data containing a content identifier that is identified with a value of ‘0×01’ and payload data containing a trigger that is identified with a value of ‘0×02’.

The payload data containing the content identifier, in one embodiment, includes one or a combination of a universal unique identifier in accordance with the Entertainment Identifier Registry (EIDR) for program material and an Ad-ID identifier for commercial material. In other embodiments, the content identifier payload may contain any other identifier that may be used to identify associated content.

“Payload sequence” is an 8-bit unsigned integer value that is incremented by 1 modulo 256 when any change in the wm_payload( )occurs. Receivers may use the payload sequence to disregard repeated messages.

“Payload length” is a 6-bit integer that specifies the number of bytes of the video_{—} watermark( )that immediately follow the payload length field, to the end of and in one embodiment, including the CRC 32 field.

“CRC 32” is a 32-bit field that contains a the CRC value that gives a zero output of the registers in the decoder defined in MPEG Systems ISO/IEC 13818-1, which is incorporated by reference in its entirety, after processing the entire video_watermark( )data structure.

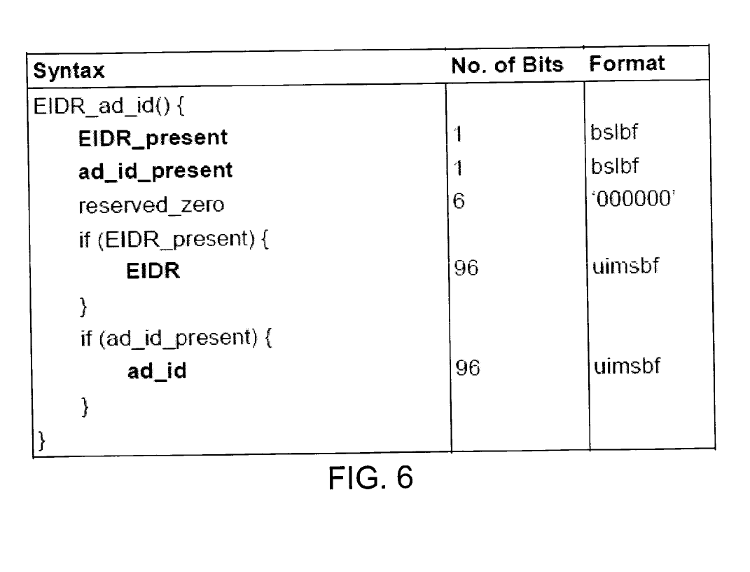

FIG. 6 provides an exemplary payload bit stream syntax of a EIDR and/or Ad-ID payload. “EIDR present” is a 1-bit flag that indicates, when set to value ‘1’, that a 96-bit EIDR is present in the message. When EIDR present is set to value ‘0’, the 96-bit EIDR field is not present. “Ad-ID present” is a 1-bit flag that indicates, when set to value ‘1’, that the 96-bit Ad_ID is present in the message. When Ad-ID present is set to value ‘0’, the 96-bit Ad-ID field is not present.

“EIDR” is a 96-bit field that represents the EIDR unique identifier associated with the content. “Ad-ID” is a 96-bit field that represents the Ad-ID code associated with the content.

The timing recovery data may be utilized in conjunction with the EIDR and/or Ad-ID payload (or other content identifier payload types) to, for example, identify the first frame of an ad segment, a program, or other content (e.g., accurately identify the timing boundary between the program and the ad); reset a media time clock at the beginning of a program, ad, or other content; record content; and remove supplemental content from a display at predetermined times (e.g., during a commercial break).

Payload data containing a trigger, in one embodiment, includes an interactive TV trigger as specified in the ATSC Candidate Standard: Interactive Services Standard (A/105:2014, S13-2-389r7). Trigger payload data, however, is not limited to an ATSC interactive television trigger and may contain any signaling element whose function, for example, is to identify signaling and establish timing of the execution of a predetermined process (e.g., playout of one or more interactive events).

An ATSC 2.0 interactive TV trigger has three parts: <domain name part>/<directory path> [?<parameters>]. The first two parts are required while the third part is optional. The <domain name part> references a registered Internet domain name. The <directory path> is an arbitrary string identifying a directory path under the control and management of the entity who owns rights to the identified domain name. The <parameters> part, when present, conveys one or more parameters associated with the trigger. Exemplary parameters include a media time indicating the current media time in units of milliseconds of the associated content, an event time, or an event ID of a specific event within a TPT of a TDO targeted by the event.

An exemplary format of the trigger is as follows:

xbc.tv/7a1?m=200bb7

In the exemplary format, “xbc.tv” refers to a domain name registered to an entity that will provide one or more TPTs or content associated with the trigger, such as interactive elements. “/7a1” refers to a name/directory space managed by a registered owner of the domain. That is, “/7a1” identifies a location of the relevant content within the designated domain. Thus, “xbc.tv/7a1” identifies a server/directory where the associated content (e.g., the interactive elements, TPT, etc.) will be found. “?m=200bb7” is the parameter portion, which is used to identify for example the media time, event (e.g., trigger event ID), timing updates (e.g., new time of specified TPT event), etc. The parameter value is the number of milliseconds since the start of the media, represented as a hexadecimal value.

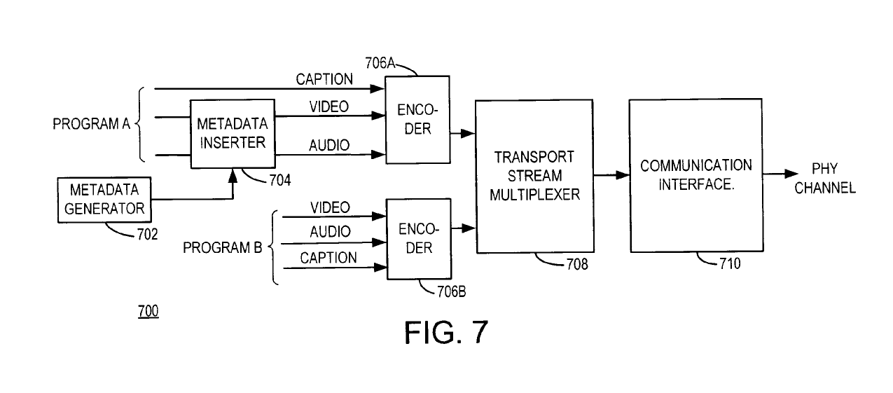

FIG. 7 is a basic diagram of an exemplary information providing apparatus 700, which for example is utilized by the content provider 10. Generally speaking, a single content provider may provide multiple programs (e.g. Programs A and B) over one or more transport streams. For example, audio, video, and caption data for Program A are provided to an encoder 706A while audio, video, and caption data for Program B are provided to an encoder 706B. A transport stream multiplexer 708 receives the outputs from the encoders 706A, 706B and provides an output that can be distributed via a physical channel medium such as a terrestrial, cable, satellite broadcast. A communication interface 710 (e.g., a broadcast transmitter) distributes the output from the transport stream multiplexer via the physical channel medium.

The information providing apparatus 700 further includes a metadata generator 702 and metadata inserter 704. The metadata generator 702 generates metadata to be embedded in one or a combination of the audio and video portions of Program A. In certain embodiments, the metadata generator 702 generates the video watermark as discussed above with respect to FIG. 5. For example, the metadata generator 702 generates a plurality of video watermarks containing the same payload data but with different timing recovery data (e.g., repeat sequence information).

The metadata inserter 704 embeds the generated metadata in one or a combination of the audio and video portions of Program A. In certain embodiments, the metadata inserter 704 encodes the generated metadata within luminance values in one or more lines (e.g., lines 1 and optionally line 2) of active video. The metadata inserter 702 encodes each of the metadata in a different frame, or each of the one or more lines, of the video. A predetermined number of frames separates each of the frames having the metadata encoded therein. The predetermined number of frames is either pre-stored in the reception apparatus 20 or provided to the reception apparatus 20, as noted above.

The metadata inserter 704 optionally repeats the encoding of the generated metadata in line 2 for better robustness due to errors that may be introduced in encoding or re-encoding. Due to the nature of video encoding, the integrity of metadata on line 1 has been found to be improved if the same data is repeated on line 2.

Video in line 1 consists of N encoded pixels (for HD or UHD content, usually 1280, 1920, or 3840); one watermark data symbol is encoded into M pixels (where M is typically 6, 8, or 16). If desired, the same method can be employed for content encoded with less than 1280 pixels horizontal resolution, with accordingly lower payload size per frame.

Each symbol encodes one or typically two data bits. When one-bit-per-symbol encoding is used, symbol values can be either zero or 100% and a threshold value of 50% luminance is used to distinguish ‘1’ bits from ‘0’ bits. When two-bits-per-symbol coding is used, symbol values can be zero, 33.33%, 66.67%, or 100% luminance, and threshold values of 16.67%, 50%, and 83.33% may be used.

The number of horizontal pixels representing one symbol varies depending on horizontal resolution. In one embodiment, 16 pixels per symbol for the 3840 horizontal resolution is utilized to allow the video watermark to be preserved during down-resolution from 4K to 2K.

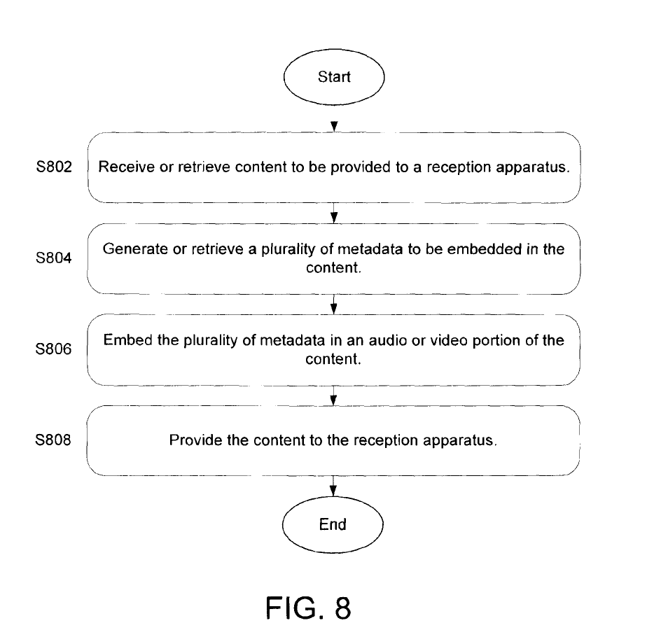

FIG. 8 is a flow diagram of an exemplary method of providing metadata associated with content to be reproduced by the reception apparatus 20. In step S802, the content provider 10 receives or otherwise retrieves content to be provided to the reception apparatus 20. In step S804, the content provider 10 generates or retrieves a plurality of metadata to be embedded in, or otherwise inserted, in the content. In step S806, the content provider 10 embeds the plurality of metadata in an audio and/or video portion of the content. In step S808, the content provider 10 provides the content to the reception apparatus 20. As described above, the content provider 10 includes circuitry, for example as illustrated in FIG. 7, to perform the metadata providing method of FIG. 8.

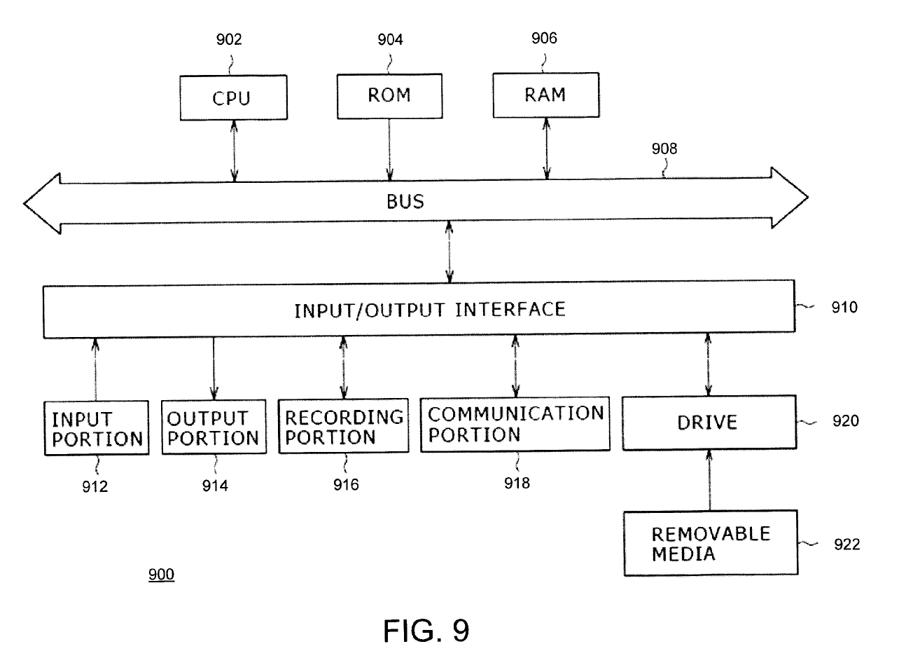

FIG. 9 is a block diagram showing an example of a hardware configuration of a computer 900 configured to function as, or control, any one or a combination of the content provider 10, reception apparatus 20, ACR system 40, and auxiliary content server 50.

As illustrated in FIG. 9, the computer 900 includes a central processing unit (CPU) 902, read only memory (ROM) 904, and a random access memory (RAM) 906 interconnected to each other via one or more buses 908. The one or more buses 908 is further connected with an input-output interface 910. The input-output interface 910 is connected with an input portion 912 formed by a keyboard, a mouse, a microphone, remote controller, etc. The input-output interface 910 is also connected to a output portion 914 formed by an audio interface, video interface, display, speaker, etc.; a recording portion 916 formed by a hard disk, a non-volatile memory, etc.; a communication portion 918 formed by a network interface, modem, USB interface, FireWire interface, etc.; and a drive 920 for driving removable media 922 such as a magnetic disk, an optical disk, a magneto-optical disk, a semiconductor memory, etc.

According to one embodiment, the CPU 902 loads a program stored in the recording portion 916 into the RAM 906 via the input-output interface 910 and the bus 908, and then executes a program configured to provide the functionality of the one or combination of the content provider 10, reception apparatus 20, ACR system 40, and auxiliary content server 50.

The various processes discussed above need not be processed chronologically in the sequence depicted as flowcharts; the steps may also include those processed parallelly or individually (e.g., in paralleled or object-oriented fashion).

Also, the programs may be processed by a single computer or by a plurality of computers on a distributed basis. The programs may also be transferred to a remote computer or computers for execution.

Furthermore, in this specification, the term “system” means an aggregate of a plurality of component elements (apparatuses, modules (parts), etc.). All component elements may or may not be housed in a single enclosure. Therefore, a plurality of apparatuses each housed in a separate enclosure and connected via a network are considered a network, and a single apparatus formed by a plurality of modules housed in a single enclosure are also regarded as a system.

Also, it should be understood that this technology when embodied is not limited to the above-described embodiments and that various modifications, variations and alternatives may be made of this technology so far as they are within the spirit and scope thereof.

For example, this technology may be structured for cloud computing whereby a single function is shared and processed in collaboration among a plurality of apparatuses via a network.

Also, each of the steps explained in reference to the above-described flowcharts may be executed not only by a single apparatus but also by a plurality of apparatuses in a shared manner.

Furthermore, if one step includes a plurality of processes, these processes included in the step may be performed not only by a single apparatus but also by a plurality of apparatuses in a shared manner.

Numerous modifications and variations of the embodiments of the present disclosure are possible in light of the above teachings. It is therefore to be understood that within the scope of the appended claims, the embodiments may be practiced otherwise than as specifically described herein.

The above disclosure also encompasses the embodiments noted below.

(1) A method of a reception apparatus for processing metadata, the method including: processing content that includes a plurality of metadata embedded therein for presentation to a user, each of the metadata including the same payload data and different timing recovery data; extracting, by circuitry of the reception apparatus and as the content is processed, one of the plurality of metadata from an audio or video portion of the content; and determining, by the circuitry of the reception apparatus, whether a first instance of the payload data is included in the extracted one of the plurality of metadata based on the timing recovery data included in the extracted one of the plurality of metadata.

(2) The method of feature (1), in which the plurality of metadata are embedded as a plurality of watermarks in the video portion of the content.

(3) The method of features (1) or (2), in which the timing recovery data included in the extracted one of the plurality of metadata identifies which instance of the payload data is included in the extracted one of the plurality of metadata.

(4) The method of any of features (1) to (3), the method further including: recovering, by the circuitry of the reception apparatus, a timing of the first instance of the payload data based on the timing recovery data included in the extracted one of the plurality of metadata when the first instance of the payload data is not included in the extracted one of the plurality of metadata.

(5) The method of any of features (1) to (4), in which each of the metadata includes one or a combination of a data indicator that identifies the presence of the respective metadata, a protocol version of the respective metadata, a payload type that identifies a type of the payload data included in the respective metadata, and payload sequence information that indicates when a change in the payload data occurs.

(6) The method of any of features (1) to (5), in which the payload data includes a content identifier associated with the content.

(7) The method of any of features (1) to (6), in which the payload data includes a trigger that signals the circuitry of the reception apparatus to perform a predetermined process according to a timing of the first instance of the payload data.

(8) The method of any of features (1) to (7), in which the extracted one of the plurality of metadata is encoded within luminance values in at least line 1 of a video frame of the content.

(9) The method of any of features (1) to (8), in which the first instance of the payload data is the first instance of a repeated sequence of the payload data.

10) A non-transitory computer-readable storage medium storing a program, which when executed by a computer causes the computer to perform a method of any of features (1) to (9).

(11) A reception apparatus, including circuitry configured to process content that includes a plurality of metadata embedded therein for presentation to a user, each of the metadata including the same payload data and different timing recovery data, extract, as the content is processed, one of the plurality of metadata from an audio or video portion of the content, and determine whether a first instance of the payload data is included in the extracted one of the plurality of metadata based on the timing recovery data included in the extracted one of the plurality of metadata

(12) The reception apparatus of feature (11), in which the plurality of metadata are embedded as a plurality of watermarks in the video portion of the content.

(13) The reception apparatus of feature (11) or (12), in which the timing recovery data included in the extracted one of the plurality of metadata identifies which instance of the payload data is included in the extracted one of the plurality of metadata.

(14) The reception apparatus of any of features (11) to (13), in which the circuitry is further configured to: recover a timing of the first instance of the payload data based on the timing recovery data included in the extracted one of the plurality of metadata when the first instance of the payload data is not included in the extracted one of the plurality of metadata.

(15) The reception apparatus of any of features (11) to (14), in which each of the metadata includes one or a combination of a data indicator that identifies the presence of the respective metadata, a protocol version of the respective metadata, a payload type that identifies a type of the payload data included in the respective metadata, and payload sequence information that indicates when a change in the payload data occurs.

(16) The reception apparatus of any of features (11) to (15), in which the payload data includes a content identifier associated with the content.

(17) The reception apparatus of any of features (11) to (16), in which the payload data includes a trigger that signals the circuitry to perform a predetermined process according to a timing of the first instance of the payload data.

(18) The reception apparatus of any of features (11) to (17), in which the one of the plurality of metadata is encoded within luminance values in at least line 1 of a video frame of the content.

(19) The reception apparatus of any of features (11) to (18), in which the first instance of the payload data is the first instance of a repeated sequence of the payload data.

(19) An information providing apparatus, including circuitry configured to receive or retrieve content to be provided to a reception apparatus, embed a plurality of metadata in an audio or video portion of the content, each of the metadata including the same payload data and different timing recovery data, and provide the content to the reception apparatus. The different timing recovery data included in each of the metadata indicates whether the respective metadata includes the first instance of the payload data.

(20) The information providing apparatus of feature (19), in which the circuitry is further configured to: generate or receive the plurality of metadata, the plurality of metadata being luma-encoded.

1. A method of a reception apparatus for processing metadata, the method comprising:
processing content that includes a plurality of metadata embedded therein for presentation to a user, each of the metadata including the same payload data and different timing recovery data;
extracting, by circuitry of the reception apparatus and as the content is processed, one of the plurality of metadata from an audio or video portion of the content; and
determining, by the circuitry of the reception apparatus, whether a first instance of the payload data is included in the extracted one of the plurality of metadata based on the timing recovery data included in the extracted one of the plurality of metadata.

2. The method according to claim 1, wherein the plurality of metadata are embedded as a plurality of watermarks in the video portion of the content.

3. The method according to claim 1, wherein the timing recovery data included in the extracted one of the plurality of metadata identifies which instance of the payload data is included in the extracted one of the plurality of metadata.

4. The method according to claim 1, further comprising:
recovering, by the circuitry of the reception apparatus, a timing of the first instance of the payload data based on the timing recovery data included in the extracted one of the plurality of metadata when the first instance of the payload data is not included in the extracted one of the plurality of metadata.

5. The method according to claim 1, wherein each of the metadata includes one or a combination of a data indicator that identifies the presence of the respective metadata, a protocol version of the respective metadata, a payload type that identifies a type of the payload data included in the respective metadata, and payload sequence information that indicates when a change in the payload data occurs.

6. The method according to claim 1, wherein the payload data includes a content identifier associated with the content.

7. The method according to claim 1, wherein the payload data includes a trigger that signals the circuitry of the reception apparatus to perform a predetermined process according to a timing of the first instance of the payload data.

8. The method according to claim 1, wherein the extracted one of the plurality of metadata is encoded within luminance values in at least line 1 of a video frame of the content.

9. A non-transitory computer-readable storage medium storing a program, which when executed by a computer causes the computer to perform a method of a reception apparatus for processing metadata, the method comprising:
processing content that includes a plurality of metadata embedded therein for presentation to a user, each of the metadata including the same payload data and different timing recovery data;
extracting, as the content is processed, one of the plurality of metadata from an audio or video portion of the content; and
determining whether a first instance of the payload data is included in the extracted one of the plurality of metadata based on the timing recovery data included in the extracted one of the plurality of metadata

10. A reception apparatus, comprising:
circuitry configured to
process content that includes a plurality of metadata embedded therein for presentation to a user, each of the metadata including the same payload data and different timing recovery data,
extract, as the content is processed, one of the plurality of metadata from an audio or video portion of the content, and
determine whether a first instance of the payload data is included in the extracted one of the plurality of metadata based on the timing recovery data included in the extracted one of the plurality of metadata

11. The reception apparatus according to claim 10, wherein the plurality of metadata are embedded as a plurality of watermarks in the video portion of the content.

12. The reception apparatus according to claim 10, wherein the timing recovery data included in the extracted one of the plurality of metadata identifies which instance of the payload data is included in the extracted one of the plurality of metadata.

13. The reception apparatus according to claim 10, wherein the circuitry is further configured to:
recover a timing of the first instance of the payload data based on the timing recovery data included in the extracted one of the plurality of metadata when the first instance of the payload data is not included in the extracted one of the plurality of metadata.

14. The reception apparatus according to claim 10, wherein each of the metadata includes one or a combination of a data indicator that identifies the presence of the respective metadata, a protocol version of the respective metadata, a payload type that identifies a type of the payload data included in the respective metadata, and payload sequence information that indicates when a change in the payload data occurs.

15. The reception apparatus according to claim 10, wherein the payload data includes a content identifier associated with the content.

16. The reception apparatus according to claim 10, wherein the payload data includes a trigger that signals the circuitry to perform a predetermined process according to a timing of the first instance of the payload data.

17. The reception apparatus according to claim 10, wherein the one of the plurality of metadata is encoded within luminance values in at least line 1 of a video frame of the content.

18. An information providing apparatus, comprising:
circuitry configured to
receive or retrieve content to be provided to a reception apparatus,
embed a plurality of metadata in an audio or video portion of the content, each of the metadata including the same payload data and different timing recovery data, and
provide the content to the reception apparatus, wherein
the different timing recovery data included in each of the metadata indicates whether the respective metadata includes the first instance of the payload data.

19. The information providing apparatus according to claim 18, wherein the circuitry is further configured to:
generate or receive the plurality of metadata, the plurality of metadata being luma-encoded.
